(19) United States
(12) Patent Application Publication
(10) Pub. No.: US 2010/0056165 A1
(43) Pub. Date: Mar. 4, 2010

(54) RESOURCE ALLOCATION METHOD IN MOBILE COMMUNICATION SYSTEM

(75) Inventors: Ji Hyung KIM, Daejeon (KR); Woo Ram SHIN, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/336,591

(22) Filed: Dec. 17, 2008

(30) Foreign Application Priority Data
Aug. 26, 2008 (KR) 10-2008-0083477

(51) Int. Cl. H04W 72/06

(52) U.S. Cl. 455/450

(57) ABSTRACT

The present invention relates to a resource allocation method in a mobile communication system. The present invention determines a resource block allocated to a high-speed mobile station by using a resource block allocated to a low-speed mobile station, and allocates resource blocks that are allocated to the low-speed mobile station and the high-speed mobile station to different frequencies at the same temporal point by using frequency division multiplexing.

### CROSS-REFERENCE TO RELATED APPLICATION

This application claims priority to and the benefit of Korean Patent Application No. 10-2008-0083477 filed in the Korean Intellectual Property Office on Aug. 26, 2008, the entire contents of which are incorporated herein by reference.

### BACKGROUND OF THE INVENTION

(a) Field of the Invention

The present invention relates to a resource allocation in a mobile communication system.

This work was supported by the IT R&D program of MIC/IITA [2008-F-002-01, Source Technology Development of Next Generation Defense Communication].

(b) Description of the Related Art

In order to compensate distortion of symbol size and phase by multipath attenuation caused by a radio channel, the mobile communication system uses a channel estimation method using a pilot signal. Here, the pilot signal represents a signal with a structure or a format predefined by a transmitter and a receiver. The pilot signal is allocated to part of subcarriers in a radio resource allocation block, and the receiver can estimate a channel value of the corresponding channel by using the pilot signal.

The method for arranging resource allocation blocks and pilot signals that is efficient in the low-speed movement condition in which a mobile station moves slowly may be inefficient in the high-speed movement condition in which inter-carrier interference (ICI) occurs. Therefore, a method for linking efficient resource allocation blocks in the low-speed movement condition and efficient resource allocation blocks in the high-speed movement condition, and a method for designing resource allocation blocks and pilot signals that is appropriate for the high-speed movement condition, are required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an efficient resource allocation method in the high-speed movement condition.

An exemplary embodiment of the present invention provides a method for allocating a resource to a first mobile station moving at a speed greater than a first reference speed in a mobile communication system, including: when receiving a resource allocation request from the first mobile station, determining a structure of a first resource block to be allocated to the first mobile station; and allocating a resource to the first mobile station so that a second resource block allocated to a second mobile station moving at a speed less than the first reference speed and the first resource block may be allocated to different frequencies at the same temporal point.

According to the embodiment of the present invention, system performance is improved by allocating a resource allocation block to the user in the high-speed movement condition when he requires it. Further, the embodiment of the present invention is efficient for the future IMT-advanced communication condition since it proposes resource allocation blocks appropriate for the high-speed movement condition.

### BRIEF DESCRIPTION OF THE DRAWINGS

FIG. 1 shows a flowchart of a resource allocation method in a mobile communication system according to an exemplary embodiment of the present invention.

FIG. 2 shows resource blocks that are allocated to a low-speed mobile station and a high-speed mobile station according to an exemplary embodiment of the present invention.

FIG. 3 shows a resource allocation method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a mobile station (MS) may indicate a terminal, a mobile terminal (MT), a subscriber station (SS), a portable subscriber station (PSS), user equipment (UE), and an access terminal (AT), and may include entire or partial functions of the terminal, the mobile terminal, the subscriber station, the portable subscriber station, the user equipment, and the access terminal.

In the specification, a base station (BS) may indicate an access point (AP), a radio access station (RAS), a nodeB (Node-B), an evolved Node-B (eNB), a base transceiver station (BTS), and a mobile multihop relay (MMR)-BS, and it may include entire or partial functions of the access point, the wireless radio access station, the nodeB, the eNB, the base transceiver station, and the MMR-BS.

A resource allocation method in a mobile communication system according to an exemplary embodiment of the present invention will now be described with reference to accompanying drawings. Particularly, a resource allocation method in the orthogonal frequency division multiple access (OFDMA) communication system will be exemplified in an exemplary embodiment of the present invention.

A mobile station of a user who moves fast will be referred to as a high-speed movement mobile station, and a mobile station of a user who moves slowly will be referred to as a low-speed movement mobile station. Here, the high-speed mobile station represents a mobile station moving at the speed of greater than 200 km/h, and the low-speed mobile station represents a mobile station moving at the speed of less than 200 km/h, but they are not limited thereto.

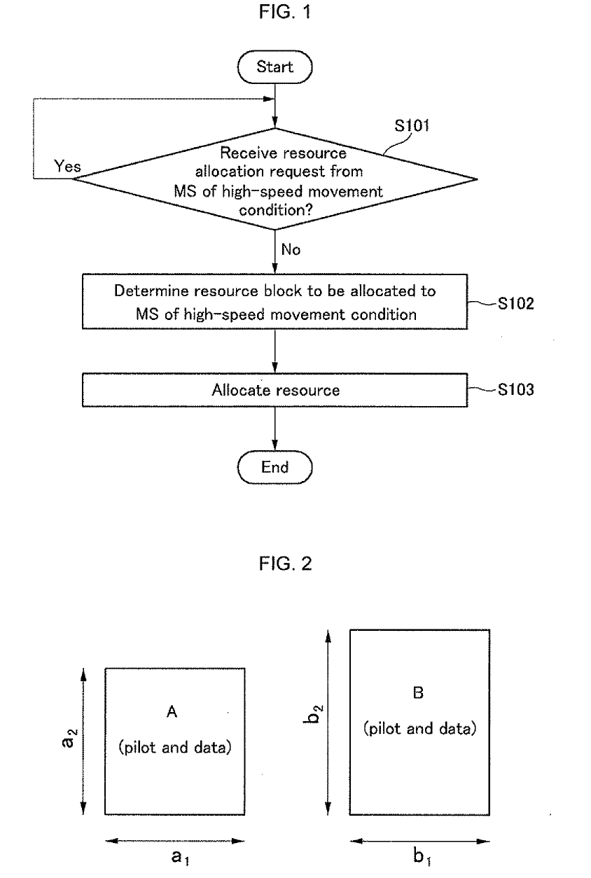

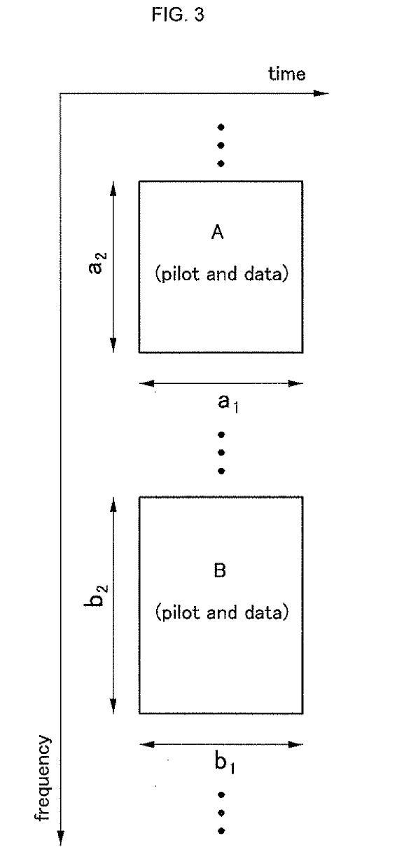

FIG. 1 shows a flowchart of a resource allocation method in a mobile communication according to an exemplary embodiment of the present invention system, showing a case in which a resource allocation device located at the base station allocates a resource to the high-speed mobile station. FIG. 2 shows resource blocks that are allocated to a low-speed mobile station and a high-speed mobile station according to an exemplary embodiment of the present invention. FIG. 3 shows a resource allocation method according to an exemplary embodiment of the present invention.

Referring to FIG. 1, a resource allocation device checks whether mobile stations having requested resource allocation include a high-speed mobile station (S101). When the high-speed mobile station has requested resource allocation, a resource block to be allocated to the high-speed mobile station is determined (S102). The resource allocation device allocates no resource for the high-speed mobile station when receiving no resource allocation request from the high-speed mobile station. Resultantly, when a request is provided by the high-speed mobile station, the method for allocating an additional resource to the high-speed mobile station has advantages of preventing resource waste and improving system performance.

In order to determine the resource block to be allocated to the high-speed mobile station, the resource allocation device uses the resource block allocated to the low-speed mobile station. First, as shown in FIG. 2, the resource block allocated to the low-speed mobile station (“resource block A”) has the width of a1 on the time axis and has a2 subcarriers on the frequency axis, pilot signals are allocated to some subcarriers in the resource block, and data are allocated to other subcarriers. Further, the resource block allocated to the high-speed mobile station (“resource block B”) has the width of b1 on the time axis and has b2 subcarriers on the frequency axis, and in a like manner of the resource block A, pilot signals are allocated to some of the subcarriers and data are allocated to the other subcarriers. The number of pilot signals and the arrangement thereof in the resource block B can be different from the number of pilot signals and the arrangement thereof in the resource block A.

In the exemplary embodiment of the present invention, the resource block B is configured to satisfy a subsequent condition.

First, the width b1 of the resource block B on the time axis is set to correspond to the width a1 of the resource block A on the time axis or it is set to be divisors or multiples thereof. Also, the number b2 of subcarriers on the frequency axis of the resource block B is expressed as Equation 1 when the number of subcarriers available for one OFDMA symbol is given as U.

U=m*a₂+n*b₂, where m and n are random integers. (Equation 1)

That is, in order to allocate the resource to the low-speed mobile station and the high-speed mobile station according to the frequency division multiplexing (FDM) method, the resource allocation device determines the number b2 of the subcarriers that are allocated to the frequency axis of the resource block B so that the value that is generated by multiplying the respective numbers of the subcarriers corresponding to the frequency axes of the resource block A and the resource block B that are allocated at the same temporal point by random integers and summing them may correspond to the number of subcarriers available in the mobile communication system.

Also, the number b2 of subcarriers allocated to the frequency axis of the resource block B is determined to support part of the formats (including the number of subcarriers allocated to the data, the number (N_{EP}) of the encoded packets included in the resource block A, the number (N_{sch}) of subchannels allocated to the resource block A, the coding rate, and the modulation method) of the resource block A. Here, the number of subcarriers of the data included in the resource block A is determined according to the number of pilot signals allocated to the resource block A, and the format and the modulation order of the resource block A is determined according to the number (excluding puncturing) of subcarriers of the data included in the resource block A and the channel coding rate.

When the time axis and the frequency axis of the resource block B are determined, the resource allocation device determines the number and arrangement of the pilot signals allocated to the resource block B. First, since the resource block B is allocated to the high-speed mobile station, a pilot signal is allocated for each symbol to estimate the ICI, and the pilot signals are arranged by not a single pilot signal but by respective packs of at least two pilot signals. Also, when the channels for at least 2 antennas are identifiable, the ratio of pilot signals allocated to the resource block B is set to be not greater than 45% of the entire resource blocks (b₁*b₂) included in the resource block B. Thus, the pilot signals that are allocated to the resource block B can be used for the high-speed mobile station rather than the low-speed mobile station.

Referring to FIG. 1, when the structure of the resource block B is determined, the resource allocation device allocates the resource to the high-speed mobile station by using the resource block B (S103). Here, the resource allocation device uses the FDM method to control the resource block A allocated to the low-speed mobile station and the resource block B allocated to the high-speed mobile station to be allocated to different frequencies at the same time, as shown in FIG. 3. The low-speed mobile station and the high-speed mobile station having received the resource blocks provided on the same time axis can identify the resource blocks that are allocated with each other through a control channel.

As described, the resource allocation device determines the resource block appropriate for the high-speed mobile station by using the resource block allocated to the low-speed mobile station, thereby proposing a resource allocation method appropriate for the high-speed movement condition.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for allocating a resource to a first mobile station moving at a speed greater than a first reference speed in a mobile communication system, the method comprising:
when receiving a resource allocation request from the first mobile station, determining a structure of a first resource block to be allocated to the first mobile station; and
allocating a resource to the first mobile station so that a second resource 1o block allocated to a second mobile station moving at a speed less than the first reference speed and the first resource block may be allocated to different frequencies at the same temporal point.

2. The method of claim 1, wherein
the determining includes:
determining a width corresponding to the time axis of the first resource block to be equal to a width corresponding to the time axis of the second resource block or to be a divisor or a multiple thereof; and
determining a number of subcarriers corresponding to the frequency axis of the first resource block so that the value that is generated by multiplying a respective number of subcarriers corresponding to frequency axes of the first resource block and the second resource block by a random integer and summing the multiplied numbers may correspond to a number of subcarriers available for the mobile communication system.

3. The method of claim 2, wherein
the determining a number of subcarriers includes
determining a number of subcarriers corresponding to the frequency axis of the first resource block so as to support a format of the second resource block more than a predetermined part.

4. The method of claim 3, wherein
the format is determined by a number of subcarriers of data included in the second resource block and a channel coding rate of the second resource block.

5. The method of claim 2, wherein
the determining of a first resource block includes
allocating a pilot signal for each symbol of the first resource block so as to allow inter-carrier interference.

6. The method of claim 5, wherein
the allocating of a pilot signal includes
arranging the pilot signals by a plurality of packs.

7. The method of claim 2, wherein
the first mobile station and the second mobile station identify the first resource block and the second resource block through a control channel.
